(19) United States
(12) Patent Application Publication
(10) Pub. No.: US 2016/0352000 A1
(43) Pub. Date: Dec. 1, 2016

(54) ANTENNA DEVICE, WIRELESS COMMUNICATION DEVICE, AND ELECTRONIC DEVICE

(71) Applicant: Panasonic Intellectual Property Management Co., Ltd., Osaka (JP)

(72) Inventors: Takeshi OHNO, Osaka (JP); Sotaro SHINKAI, Osaka (JP)

(21) Appl. No.: 15/232,289

(22) Filed: Aug. 9, 2016

Related U.S. Application Data
(63) Continuation of application No. PCT/JP2015/001076, filed on Mar. 2, 2015.

(30) Foreign Application Priority Data
Mar. 7, 2014 (JP) 2014-045673

(51) Int. Cl. H01Q 1/24; H01Q 9/06

(52) U.S. Cl. CPC H01Q 1/243; H01Q 9/065

(57) ABSTRACT

An antenna apparatus includes a dielectric substrate, a feed element, a front array, and side arrays. The feed element, front array, and side arrays are formed on the dielectric substrate. The antenna apparatus includes mounting pads on the dielectric substrate, for coupling the antenna apparatus to another substrate by means of soldering. A part of the mounting pads are formed in a region located in a first direction when viewed from the feed element and front array, with a part of parasitic elements of the side arrays being interposed between these mounting pads and the feed element and front array. The other part of the mounting pads are formed in a region in a second direction when viewed from the feed element and front array, with another part of the parasitic elements of the side arrays being interposed between these mounting pads and the feed element and front array.

### BACKGROUND

1. Technical Field

The present disclosure relates to antenna apparatuses each of which offers directivity in a specific direction. The disclosure also relates to wireless communication apparatuses and electronic apparatuses, with each of these apparatuses being equipped with such an antenna apparatus.

2. Description of the Related Art

End-fire array antennas have been known which each have a feed element and a parasitic element array that includes a plurality of parasitic elements disposed in front of the feed element, thereby enhancing directivity of the antennas. Such an end-fire array antenna offers the directivity in the direction in which the parasitic element array is positioned when viewed from the feed element, and thus performs input and output of electromagnetic waves in the direction.

Japanese Patent Unexamined Publication No. 2009-182948 discloses an end-fire array antenna which can achieve high-gain characteristics under the condition that its dielectric substrate is shortened in length.

Japanese Patent Unexamined Publication No. 2009-194844 discloses an antenna apparatus which is configured with a feed element and a plurality of parasitic elements disposed in parallel with the feed element.

Japanese Patent Unexamined Publication No. 2009-017515 discloses an antenna apparatus which can achieve a reduced propagation of a surface wave, by mounting elements having resonance characteristics on the periphery of a patch antenna area of the antenna apparatus.

Japanese Utility Model Unexamined Publication No. S64-016725 discloses an antenna equipped with an antenna element, having a Yagi antenna structure, which is disposed in the inside of a box.

International Publication WO 2012/164782 discloses an end-fire array antenna which has a feed element and a parasitic element array that includes a plurality of parasitic elements disposed in front of the feed element.

In some cases, a first substrate on which elements such as electronic circuit components and passive components are mounted is equipped with a second substrate on which an antenna is formed, with the second being disposed on the first. In these cases, the second substrate may be connected to the first substrate by means of soldering, in the same manner as for other elements mounted on the first substrate. For example, the first and second substrates each have a plurality of mounting pads, with the pads of one of the substrates facing corresponding ones of the other substrate. Then, solder balls are disposed for the mounting pads, and then heated to connect the second substrate to the first substrate. If the mounting pads and solder balls are insufficient in number for the connection or if their arranged positions are inappropriate, it is possible that the second substrate is detached when the apparatus equipped with the substrates is subjected to impacts due to a vibration or drop. Therefore, highly reliable fixing of the substrates requires additional mounting pads and additional solder balls, which are disposed additionally in the vicinity of the feed element and the like of the antenna.

Unfortunately, the additional mounting pads and solder balls disposed in the vicinity of the antenna are coupled with a radiation electric field of the antenna, which causes influence on the electromagnetic field of the antenna, resulting in a width-broadened beam, a disturbed phase-distribution of the electric field, and the like. This becomes a cause of a disturbed radiation pattern and a reduced gain.

The present disclosure is intended to provide an antenna apparatus which can be coupled with another substrate by means of soldering, with the influence on a radiation pattern being reduced. The disclosure also provides a wireless communication apparatus and an electronic apparatus which are each equipped with such an antenna apparatus.

### SUMMARY

An antenna apparatus according to embodiments of the present disclosure includes: a dielectric substrate, a feed element, a front array, a first side array, and a second side array. The feed element is formed on the dielectric substrate and offers one radiation direction. The front array includes a plurality of parasitic elements which is formed, on the dielectric substrate, in a region located in the radiation direction when viewed from the feed element. The first side array includes a plurality of parasitic elements which is formed, on the dielectric substrate, in a region located in a first direction orthogonal to the radiation direction, when viewed from the feed element and the front array. The second side array includes a plurality of parasitic elements which is formed, on the dielectric substrate, in a region located in a second direction opposite to the first direction, when viewed from the feed element and the front array. The plurality of the parasitic elements of the front array configures a plurality of front sub-arrays, with each of the front sub-arrays including a plurality of the parasitic elements that are arrayed along the radiation direction. The front sub-arrays are disposed in parallel with each other along the radiation direction such that, in any adjacent two of the front sub-arrays, each of the parasitic elements of one of the two front sub-arrays is close to a corresponding one of the parasitic elements of the other of the two. The plurality of the parasitic elements of each of the first and second side arrays is arrayed substantially along the radiation direction.

The antenna apparatus further includes, on the dielectric substrate, at least one first mounting pad and at least one second mounting pad, with the pads being used to couple the antenna apparatus to another substrate by means of soldering. The first mounting pads are formed on the dielectric substrate in a region located in the first direction when viewed from the feed element and front array. With the first mounting pads, a part of the plurality of the parasitic elements of the first side array is formed between the first mounting pads and the feed element and front array. The second mounting pads are formed on the dielectric substrate in a region located in the second direction when viewed from the feed element and front array. With the second mounting pads, a part of the plurality of the parasitic elements of the second side array is formed between the second mounting pads and the feed element and front array.

### BRIEF DESCRIPTION OF THE DRAWINGS

FIG. 1 is a perspective view of exemplary tablet terminal apparatus 101 that is equipped with antenna apparatus 108 according to a first embodiment;

FIG. 2 is a detailed plan view of a configuration of an upper surface of antenna apparatus 108 shown in FIG. 1;

FIG. 3 is a detailed plan view of a configuration of a lower surface of antenna apparatus 108 shown in FIG. 1;

FIG. 4 is an enlarged view of a part of feed element 304 and front array 305 shown in FIG. 2;

FIG. 5 is an enlarged view of a part of parasitic elements of side array 306 shown in FIG. 2;

FIG. 6 is a plan view of a configuration of antenna apparatus 108A according to a first modified example of the first embodiment;

FIG. 7 is a plan view of a configuration of antenna apparatus 108B according to a second modified example of the first embodiment;

FIG. 8 is a plan view of a configuration of an upper surface of antenna apparatus 108C according to a second embodiment;

FIG. 9 is a plan view of a configuration of a lower surface of antenna apparatus 108C shown in FIG. 8;

FIG. 10 is a plan view of a configuration of antenna apparatus 108D according to a modified example of the second embodiment;

FIG. 11 is a plan view of a configuration of antenna apparatus 208 according to a comparative example;

FIG. 12 is a chart of radiation directivity on an XY plane which shows the result of an electromagnetic field analysis of antenna apparatus 208 shown in FIG. 11;

FIG. 13 is a chart of radiation directivity on an XY plane which shows the result of an electromagnetic field analysis of antenna apparatus 108 shown in FIG. 1; and

FIG. 14 is a chart of radiation directivity on an XY plane which shows the result of an electromagnetic field analysis of antenna apparatus 108C shown in FIG. 8.

### DETAILED DESCRIPTION

Hereinafter, detailed descriptions of embodiments will be made with reference to the accompanying drawings as deemed appropriate. However, descriptions in more detail than necessary will sometimes be omitted. For example, detailed descriptions of well-known items and duplicate descriptions of substantially the same configuration will sometimes be omitted, for the sake of brevity and easy understanding by those skilled in the art.

Note that the accompanying drawings and the following descriptions are presented to facilitate fully understanding of the present disclosure by those skilled in the art and, therefore, are not intended to impose any limitations on the subject matter described in the appended claims.

An XYZ coordinate system shown in some of the drawings will be referred to for the following descriptions, as deemed appropriate.

### 1. FIRST EXEMPLARY EMBODIMENT

### 1.1. Configuration of Entire System

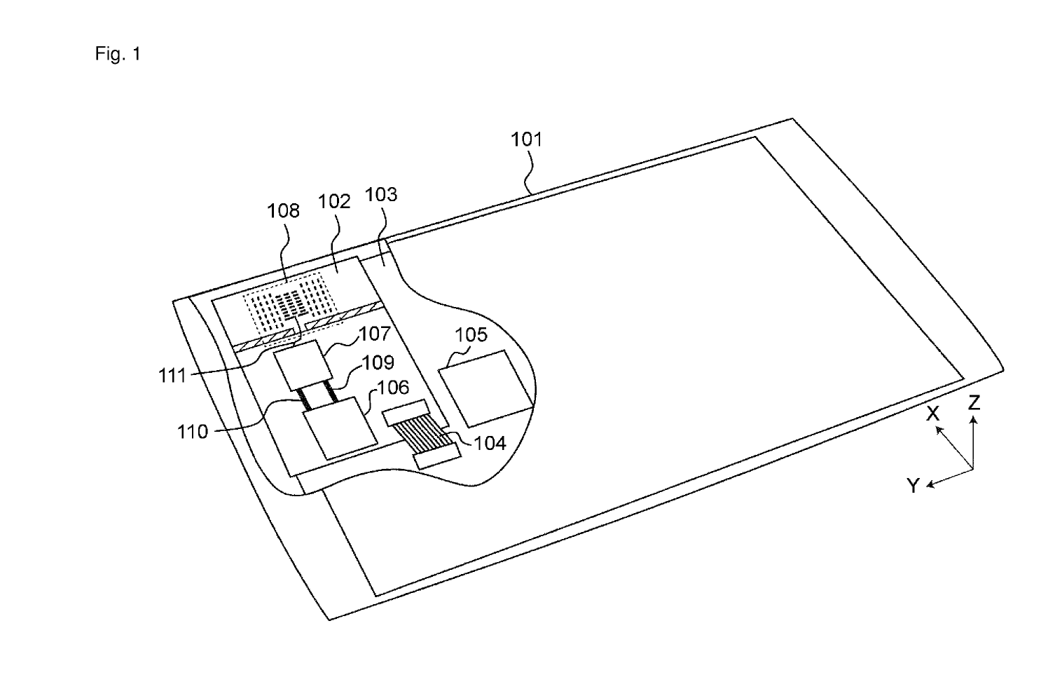

FIG. 1 is a perspective view of exemplary tablet terminal apparatus 101 that is equipped with antenna apparatus 108 according to a first embodiment. FIG. 1 shows a partially cut-away view for illustrating the internal configuration of tablet terminal apparatus 101.

Tablet terminal apparatus 101 is an electronic apparatus that is equipped with a wireless communication apparatus and a signal processor for processing signals which are transmitted and received via the wireless communication apparatus. The wireless communication apparatus includes antenna apparatus 108 and a wireless communication circuit coupled with the antenna apparatus.

Tablet terminal apparatus 101 includes two circuit boards, that is, wireless module board 102 operable as the wireless communication apparatus and host system board 103 operable as the signal processor. Wireless module board 102 is coupled with host system board 103 by means of high-speed interface cable 104.

Wireless module board 102 includes a circuit, on its printed-circuit substrate, for transmitting and receiving electromagnetic waves in a 60 GHz band in a millimeter waveband (30 GHz to 300 GHz), for example. The 60 GHz band is used in the WiGig standard (IEEE 802.11ad) for transmitting and receiving video and audio data at high speed, and the like, for example.

On wireless module board 102, there are mounted baseband-and-media access control (MAC) circuit 106, radio frequency (RF) circuit 107, and antenna apparatus 108. Baseband-and-MAC circuit 106 is coupled with RF circuit 107 via signal line 109 and control line 110. RF circuit 107 is coupled with antenna apparatus 108 via feeder line 111.

Baseband-and-MAC circuit 106 controls signal modulation and demodulation, waveform shaping, and packet transmission and reception, etc. Baseband-and-MAC circuit 106 transmits a modulated signal to RF circuit 107 via signal line 109 during the transmission, and demodulates a modulated signal received from RF circuit 107 via signal line 109 during the reception.

RF circuit 107 performs frequency conversion between a frequency of the modulated signal and a radio frequency in the millimeter waveband, for example, and performs power amplification, waveform shaping, and the like of the signal at the radio frequency. And thus, during the transmission, RF circuit 107 performs the frequency conversion of the modulated signal that is received from baseband-and-MAC circuit 106 via signal line 109, thereby generating a signal at the radio frequency and then transmitting the thus-generated signal to antenna apparatus 108 via feeder line 111. During the reception, RF circuit 107 performs the frequency conversion of the signal at the radio frequency, which is inputted via feeder line 111, and transmits the thus-converted signal to baseband-and-MAC circuit 106 via signal line 109. Then, the thus-transmitted signal is demodulated by the baseband-and-MAC circuit.

Antenna apparatus 108 is formed in the vicinity of an edge of wireless module board 102, in a conductor pattern on a printed-circuit substrate. During the transmission, antenna apparatus 108 radiates a high-frequency signal as an electromagnetic wave, with the high-frequency signal being fed from RF circuit 107 via feeder line 111. During the reception, antenna apparatus 108 receives a high-frequency signal, that is, a high-frequency current induced by an electromagnetic wave that propagates in space, and transmits the received high-frequency signal to RF circuit 107 via feeder line 111. Note that, if necessary, an impedance matching circuit (not shown) may be disposed in feeder line 111 between antenna apparatus 108 and RF circuit 107.

On host system board 103, host system circuit 105 is mounted. Host system circuit 105 includes a communication circuit and other processing circuits which compose layers (e.g., an application layer) upper than baseband-and-MAC circuit 106. For example, host system circuit 105 includes a CPU for controlling operations, such as image display, of tablet terminal apparatus 101.

Baseband-and-MAC circuit 106 communicates with host system circuit 105 via high-speed interface cable 104.

### 1.2. Configuration of Antenna Apparatus

In general, a wireless communication apparatus, which operates at high frequencies such as millimeter waves, shows a large loss in feeder line 111. To avoid this, the apparatus' antenna is disposed in the vicinity of RF circuit 107. Moreover, RF circuit 107, baseband-and-MAC circuit 106, and the like are often formed by micromachining technology to be integrated-circuits having many pins. Accordingly, these circuits are mounted not on a general-purpose dielectric substrate together with a power supply circuit and other electronics components, but often on another substrate (serving as an interposer) on which micro-wiring can be made. And thus, the antenna is commonly configured on a substrate (package substrate) on which RF circuit 107 is mounted (sometimes together with baseband-and-MAC circuit 106).

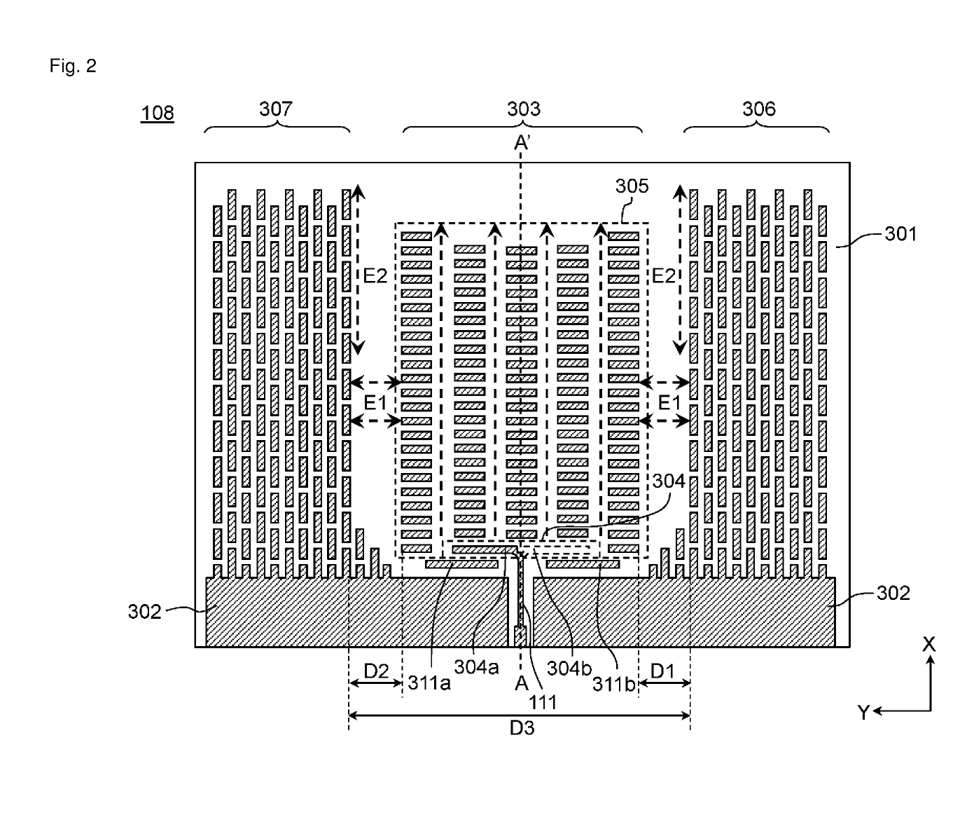

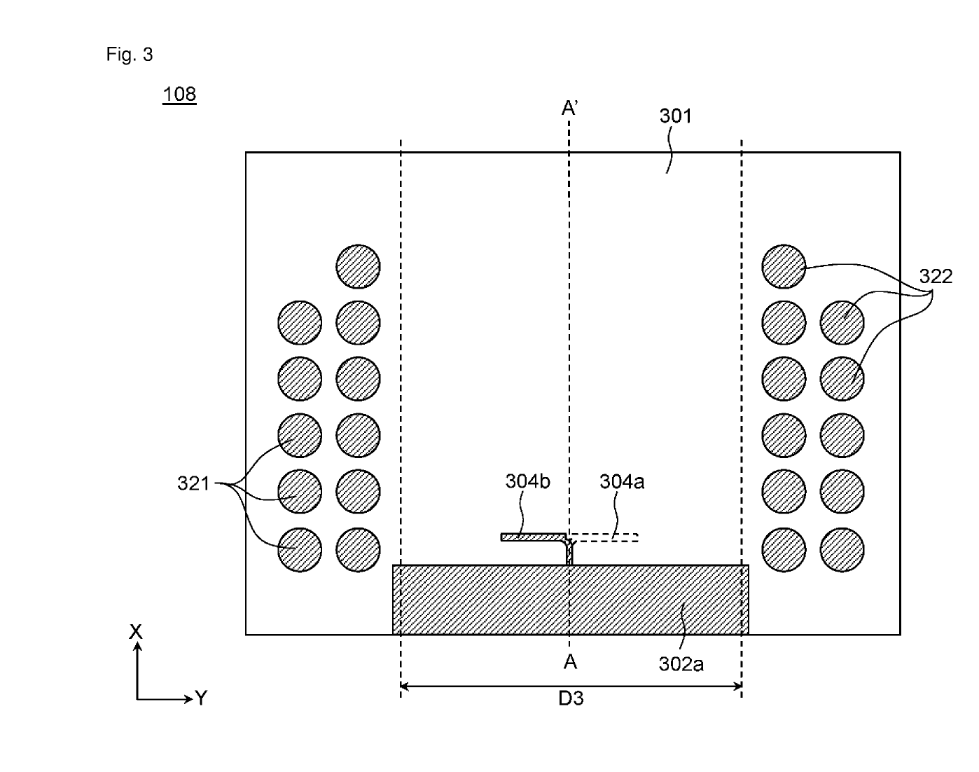

FIG. 2 is a detailed plan view of a configuration of an upper surface of antenna apparatus 108 shown in FIG. 1. FIG. 3 is a detailed plan view of a configuration of a lower surface of antenna apparatus 108 shown in FIG. 1. FIGS. 2 and 3 each show only a portion which contains antenna apparatus 108, with the portion being a part of wireless module board 102 that includes antenna apparatus 108, RF circuit 107, and baseband-and-MAC circuit 106. Likewise, this is true for other Figures illustrating antenna apparatuses according to other exemplary embodiments and their modified examples.

As shown in FIGS. 2 and 3, antenna apparatus 108 includes dielectric substrate 301, feed element 304, and front array 305. The feed element is formed on dielectric substrate 301 and offers one radiation direction (+X direction in FIG. 2). The front array includes a plurality of parasitic elements that are formed, on dielectric substrate 301, in a region located in the radiation direction when viewed from feed element 304. Feed element 304 and front array 305 operate as end-fire antenna 303 that offers the radiation direction in the +X direction in FIG. 2. Dielectric substrate 301 includes an upper surface and a lower surface, which are parallel to each other.

Antenna apparatus 108 further includes a plurality of mounting pads 321 and a plurality of mounting pads 322 (FIG. 3), on dielectric substrate 301, with these pads being used to couple antenna apparatus 108 to wireless module board 102 by means of soldering. The pluralities of mounting pads 321 and 322 include at least one first mounting pad 321 and at least one second mounting pad 322, respectively. The at least one first mounting pad is formed, on dielectric substrate 301, in a region located in a first direction (−Y direction in FIG. 3) orthogonal to the radiation direction when viewed from both feed element 304 and front array 305. The at least one second mounting pad is formed, on dielectric substrate 301, in a region located in a second direction (+Y direction in FIG. 3) opposite to the first direction when viewed from both feed element 304 and front array 305. In this way, mounting pads 321 and 322 are respectively formed, on dielectric substrate 301, in the regions located in the directions different from the radiation direction when viewed from feed element 304.

Antenna apparatus 108 further includes: first side array 306 including a plurality of parasitic elements, and second side array 307 including a plurality of parasitic elements. First side array 306 is formed, on dielectric substrate 301, in a region located in the first direction (−Y direction in FIG. 2) orthogonal to the radiation direction when viewed from both feed element 304 and front array 305. Second side array 307 is formed, on dielectric substrate 301, in a region located in the second direction (+Y direction in FIG. 2) opposite to the first direction when viewed from both feed element 304 and front array 305.

For each of first mounting pads 321, part of the plurality of the parasitic elements of first side array 306 are formed between first mounting pad 321 concerned and both feed element 304 and front array 305. Moreover, for each of second mounting pads 322, part of the plurality of the parasitic elements of second side array 307 are formed between second mounting pad 322 concerned and both feed element 304 and front array 305. Such an arrangement of the parasitic elements of side arrays 306 and 307 in this way reduces coupling between electric fields and mounting pads 321 and 322 with solder balls (not shown) located on the mounting pads, with the electric fields being generated at an area surrounding feed element 304 and an area surrounding each of the parasitic elements of front array 305. This results in a reduced influence on a radiation pattern of the antenna.

For example, as shown in FIGS. 2 and 3, all the parasitic elements of side arrays 306 and 307 are formed on the upper surface of dielectric substrate 301, and all mounting pads 321 and 322 are formed on the lower surface of dielectric substrate 301. At least a part of the parasitic elements of each of side arrays 306 and 307 may overlap mounting pads 321 and 322, respectively. Alternatively, all the parasitic elements of side array 306 may be located between mounting pad 32 land both feed element 304 and front array 305, without overlapping mounting pad 321; and all the parasitic elements of side array 307 may be located between mounting pad 322 and the both, without overlapping mounting pad 322. In the latter case, all the parasitic elements of side arrays 306 and 307 and all mounting pads 321 and 322 may be formed on the same surface of dielectric substrate 301.

Feed element 304 is a dipole antenna, the longitudinal direction of which is along the direction (direction along the Y-axis in FIG. 2) orthogonal to the radiation direction. Feed element 304 includes feed element parts 304a and 304b that are arranged substantially in a straight line. Feed element part 304a is formed on the upper surface of dielectric substrate 301, while feed element part 304b is formed on the lower surface of dielectric substrate 301, for example. The total length of feed element 304 (dipole antenna) is set to be equal to approximately half of operating wavelength λ of feed element 304 (where λ is the wavelength of electromagnetic waves transmitted and received via end-fire antenna 303), for example.

On the upper surface of dielectric substrate 301, ground conductor 302 is formed in a region located in the direction (−X direction in FIG. 2) opposite to the radiation direction when viewed from feed element 304. On the lower surface of dielectric substrate 301, ground conductor 302a is formed in a region which corresponds to the back side of ground conductor 302 formed on the upper surface of dielectric substrate 301. The presence of ground conductors 302 and 302a disposed at the respective regions allows feed element 304 to offer one radiation direction in the +X direction in FIG. 2. The potential of ground conductors 302 and 302a acts as a ground potential of wireless module board 102.

On dielectric substrate 301, antenna apparatus 108 may further include reflective elements 311a and 311b that are formed between feed element 304 and ground conductor 302 such that the longitudinal direction of the reflective elements is along the direction orthogonal to the radiation direction. The presence of reflective elements 311a and 311b disposed in the regions in the direction (−X direction in FIG. 2) opposite to the radiation direction when viewed from feed element 304, has advantages over the absence of reflective elements 311a and 311b. Such advantages include a highly efficient directivity of the electromagnetic waves radiated from feed element 304 in the end-fire direction, leading to an improved front-to-back ratio (FB ratio). Reflective elements 311a and 311b are particularly effective in directing the electromagnetic waves in the +X direction, in the case where antenna apparatus 108 is made larger in size in the direction orthogonal to the radiation direction as the number of front sub-arrays is increased. Moreover, in the absence of ground conductor 302, reflective elements 311a and 311b are particularly effective in directing electromagnetic waves in the +X direction.

On dielectric substrate 301, feeder line 111 is formed to couple feed element 304 to RF circuit 107 shown in FIG. 1. Feeder line 111 is formed on the upper surface of dielectric substrate 301 and includes a conductor element which is coupled with feed element part 304a. In addition, on the lower surface of dielectric substrate 301, feed element part 304b is coupled with ground conductor 302a.

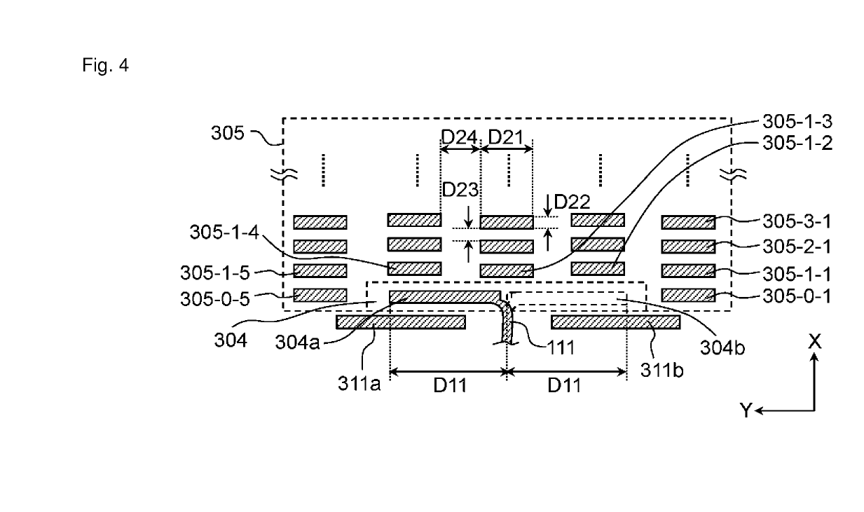

FIG. 4 is an enlarged view of a part of feed element 304 and front array 305, both shown in FIG. 2. The plurality of the parasitic elements of front array 305 configures a plurality of the front sub-arrays. Each of the sub-arrays includes a plurality of the parasitic elements that are arrayed along the radiation direction. In FIG. 4, front array 305 includes: a rightmost front sub-array, a second-rightmost front sub-array, . . . , and a leftmost front sub-array. The rightmost one includes parasitic elements 305-0-1, 305-1-1, 305-2-1, . . . ; the second-rightmost one includes parasitic elements 305-1-2, 305-2-2, . . . ; and the leftmost one includes parasitic elements 305-0-5, 305-1-5, 305-2-5, . . . . The plurality of the front sub-arrays is disposed such that the front sub-arrays are parallel to each other and along the radiation direction, and that, in any adjacent two of the front sub-arrays, each of the parasitic elements of one of the two front sub-arrays is close to corresponding one of the parasitic elements of the other of the two.

Each of the plurality of the parasitic elements of front array 305 has its longitudinal direction along the direction (along the Y-axis in FIG. 2) orthogonal to the radiation direction. Accordingly, the longitudinal direction of the parasitic elements of front array 305 is substantially parallel to the longitudinal direction of feed element 304. As shown in FIG.4, D21 and D22 denote the longitudinal length and the width, respectively, of each of the parasitic elements of front array 305. Moreover, in each of the front sub-arrays, D23 denotes the distance between two parasitic elements adjacent to each other in the longitudinal direction of the front sub-array concerned. Furthermore, two front sub-arrays adjacent to each other are disposed with predetermined distance D24 between the two. The longitudinal length of each of the parasitic elements of front array 305 is shorter than longitudinal length D 11 of each of feed element parts 304a and 304b.

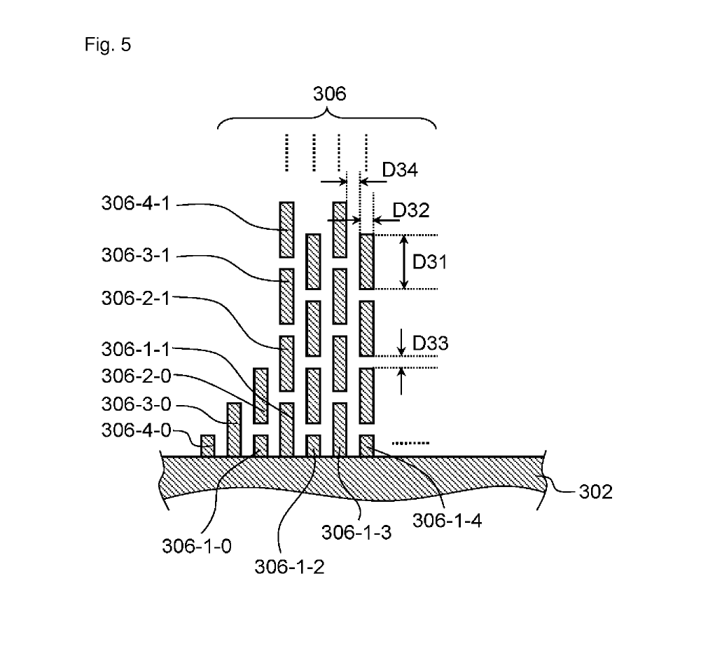

The plurality of the parasitic elements f each of side arrays 306 and 307 is arrayed substantially along the radiation direction. In each of side arrays 306 and 307, the plurality of the parasitic elements of the side array concerned particularly configures a plurality of side sub-arrays. Each of such side sub-arrays includes a plurality of the parasitic elements that are arrayed substantially along the radiation direction. FIG. 5 is an enlarged view of a part of the parasitic elements of side array 306 shown in FIG. 2. In FIG. 5, side array 306 is configured with the side sub-arrays which include: a side sub-array including parasitic elements 306-1-1, 306-2-1, . . . ; a side sub-array including parasitic elements 306-1-2, 306-2-2, . . . ; a side sub-array including parasitic elements 306-1-3, 306-2-3, . . . ; a side sub-array including parasitic elements 306-1-4, 306-2-4, . . . ; and a plurality of subsequent side sub-arrays in the same manner. The plurality of the side sub-arrays of side array 306 is disposed such that the side sub-arrays are substantially along the radiation direction and parallel to each other.

Side array 306 may further include other parasitic elements 306-1-0 to 306-4-0 which are excluded from the side sub-arrays and aimed at adjusting a propagation path of electromagnetic waves on dielectric substrate 301.

Side array 307 is configured in the same manner as for side array 306 shown in FIG. 5.

Every parasitic element of each of side arrays 306 and 307 has its longitudinal direction along the longitudinal direction of the side array concerned. As shown in FIG. 5, D31 and D32 denote the longitudinal length and the width, respectively, of each of the parasitic elements of side arrays 306 and 307. Moreover, D33 denotes the length of a gap between two parasitic elements adjacent to each other, in the longitudinal direction of each of the side arrays (i.e., in the longitudinal direction of each of the side sub-array). In each of side arrays 306 and 307, the sum of 2×D31 and D33 is smaller than a half of operating wavelength λ of feed element 304 (i.e., 2×D31+D33<λ/2), for example, where 2×D31 is the longitudinal length of two parasitic elements adjacent to each other in the longitudinal direction of the side array concerned, and D33 is the gap distance between the two parasitic elements. In this case, this configuration can suppress occurrence of resonance of the parasitic elements of each of side arrays 306 and 307, with a resonance wavelength being equal to operating wavelength λ of feed element 304.

In each of side arrays 306 and 307, any adjacent two of the side sub-arrays are disposed with predetermined distance D34 between the two. Distance D34 is set to be the smallest possible one, within a range of manufacturability of the printed-circuit substrate by means of patterning technology. This is because the smaller the distance D34 between the side sub-arrays, the higher the effect of preventing leakage of the electric field is. For example, the distance D34 between the side sub-arrays is set equal to about width D32 of each of the parasitic elements of side arrays 306 and 307.

The plurality of the side sub-arrays in each of side arrays 306 and 307 is disposed such that, in any adjacent two of the side sub-arrays of each of the side arrays, gaps between the parasitic elements of one of the two are disposed in a staggered arrangement with gaps between the parasitic elements of the other of the two. The presence of the parasitic elements, arranged in this way, of each of the side sub-arrays allows a more reliable prevention of electric field E1 from propagating beyond both side array 306 in the −Y direction and side array 307 in the +Y direction, compared to the case of the absence of the plurality of the side arrays.

Antenna apparatus 108 is configured symmetrically with respect to reference line A-A′ that extends from feed element 304 in the radiation direction. For example, distance D1 is substantially equal to distance D2, where D1 is the distance from front array 305 (i.e., from the distal end of each of the endmost parasitic elements in the −Y direction of front array 305) to side array 306, and D2 is the distance from front array 305 (i.e., from the distal end of each of the endmost parasitic elements in the +Y direction of front array 305) to side array 307. In this way, side arrays 306 and 307 are disposed symmetrically in the −Y and +Y directions, respectively, with respect to front array 305, which can reduce a phase difference between the electric fields that propagate from end-fire antenna 303 in the directions (−Y direction and +Y direction) orthogonal to the radiation direction. With this configuration, the phase difference between the electric fields that propagate in the −Y and +Y directions can be reduced, resulting in a reduction in the inclination of the direction of the radiation beam.

Distances D1 and D2 are set to be equal to about the distances between the parasitic elements of front array 305 or longer, where D1 and D2 are the distances from front array 305 to side arrays 306 and 307, respectively.

Note that, distance D3 that is the distance between side arrays 306 and 307 located on both sides of end-fire antenna 303 is set to be not smaller than approximately 1.5 times larger than operating wavelength λ of feed element 304, for example. This configuration allows antenna apparatus 108 to be less susceptible to degradation in performance caused by electromagnetic coupling between feed element 304 and each of the parasitic elements of side arrays 306 and 307.

### 1.3. Operation

Operations of antenna apparatus 108 will be described with reference to FIGS. 2 and 3.

First, descriptions will be made regarding operation of end-fire antenna 303.

The plurality of the front sub-arrays are formed substantially in parallel to each other such that any adjacent two of the front sub-arrays form a virtual slot opening (referred to as a pseudo-slot opening, hereinafter) with a predetermined width.

In each of the front sub-arrays, parasitic elements adjacent to each other in the radiation direction couple electromagnetically to each other. This causes each of the front sub-arrays to act as an electric wall extending in the radiation direction. Then, for any adjacent two of the front sub-arrays, the pseudo-slot opening is formed between the two. For this reason, when feed element 304 transmits or receives an electromagnetic wave, an electric field is generated at each pseudo-slot opening in the direction orthogonal to the radiation direction, which entails a magnetic current parallel to the radiation direction passing through the pseudo-slot opening. Accordingly, the electromagnetic wave radiated from feed element 304 propagates on the surface of dielectric substrate 301 in the radiation direction along each of the pseudo-slot openings between the front sub-arrays. Then, the electromagnetic wave is radiated in the end-fire direction, from the edge in the +X direction of dielectric substrate 301. That is, end-fire antenna 303 operates, with the pseudo-slot openings being as magnetic current sources. At this moment, at the edge in the +X direction of dielectric substrate 301, the electromagnetic waves are in phase to form an equiphase surface. Note that, in any adjacent two of the front sub-arrays, the parasitic elements of one of the two fail to couple electromagnetically to the parasitic elements of the other of the two, in the direction orthogonal to the radiation direction, which produces no resonance between them.

The plurality of the front sub-arrays is characterized in that the front sub-arrays are arranged substantially in parallel to each other at predetermined intervals to form the pseudo-slot opening for any adjacent two of the front sub-arrays. With the pseudo-slot openings, the electromagnetic wave fed from feed element 304 propagates as a magnetic current.

Consequently, in accordance with end-fire antenna 303, each of the front sub-arrays acts as the electric wall, and the pseudo-slot opening is formed between any adjacent two of the front sub-arrays. That is, end-fire antenna 303 has a configuration, for example, in which each of conductors extending in the radiation direction is divided into pieces, i.e., the plurality of the parasitic elements. And thus, the length of each of the conductor pieces is so small in the radiation direction that the electric current flowing along the pseudo-slot openings can be reduced.

In each of the front sub-arrays, distance D23 between the parasitic elements adjacent to each other in the radiation direction is set to be not larger than λ/8, for example, such that any two of the parasitic elements in the radiation direction can be electromagnetically coupled to each other. Moreover, distance D24 between two front sub-arrays adjacent to each other is set to be λ/10, for example. Furthermore, the distance between feed element 304 and the parasitic elements closest to feed element 304 is set such that these elements electromagnetically couple to each other; the distance is set to be equal to distance D23 between two parasitic elements adjacent to each other in the radiation direction, for example. In addition, the distance between feed element 304 and ground conductor 302 is set to be equal to distance D23 between two parasitic elements adjacent to each other in the radiation direction, for example.

Moreover, in each of the front sub-arrays, distance D23 between two parasitic elements adjacent to each other in the radiation direction is set as small as possible, so that such two parasitic elements adjacent in the radiation direction can provide strong electromagnetic coupling to each other via a free space on the surface of dielectric substrate 301. This allows a reduction in density of electric lines of force in the bulk of dielectric substrate 301, resulting in less influence of a dielectric loss in dielectric substrate 301. For this reason, this configuration can exhibit high-gain characteristics compared to conventional technologies.

Moreover, in accordance with end-fire antenna 303, each of the parasitic elements can be made smaller in size, resulting in a reduction in electric current induced in the parasitic element. Furthermore, in each of the front sub-arrays, distance D23 between two parasitic elements adjacent to each other in the radiation direction can be made smaller in size to reduce the dielectric loss in dielectric substrate 301. This allows downsizing of end-fire antenna 303, resulting in high-gain characteristics.

Consequently, in accordance with end-fire antenna 303, it is possible to enhance power efficiency of the wireless communication apparatus which performs communications in a frequency band, such as a millimeter waveband, that shows a relatively large propagation loss in space.

Note that, in FIG. 2, although front array 305 has five front sub-arrays, the front array is not limited to them. The front array may include not smaller than two front sub-arrays that are disposed to form a plurality of pseudo-slot openings. Note that, the longer the length of each of the front sub-arrays in the end-fire direction (the larger the number of the parasitic elements), the narrower the width of the beam in the vertical plane (XZ plane) is. Moreover, the larger the number of the front sub-arrays, the narrower the width of the beam in the horizontal plane (XY plane) is. That is, the widths of the beam in the vertical and horizontal planes can be controlled, independently of each other, by changing the length and the number of the front sub-arrays.

Next, side arrays 306 and 307 will be described.

The signal output from RF circuit 107 shown in FIG. 1 is fed to feed element 304 via feeder line 111. Upon being fed, feed element 304 is excited to generate an electric field both at an area surrounding feed element 304 and at an area surrounding each of the parasitic elements of front array 305. The thus-generated electric field contains two components. One of the components propagates in the radiation direction (+X direction) along the gaps between the parasitic elements of front array 305, and then radiates out as an electromagnetic wave. The other component (electric field E1) propagates in the directions (+Y direction and −Y direction) orthogonal to the radiation direction. Electric field E1 propagating in the +Y and −Y directions reaches the parasitic elements of side arrays 306 and 307, respectively.

Because the dimensions of each of the parasitic elements of side arrays 306 and 307 satisfy the condition (i.e., 2×D31+D33<λ/2) described with reference to FIG. 5, such parasitic elements can propagate electric field E2 in the direction along the radiation direction. However, electric field E1 orthogonal to the radiation direction is difficult to propagate through the parasitic elements. The reason for this is as follows: When electric field E1 generated in this way reaches side array 306, the side array will induce an electric field which causes electric field E1 to propagate through the side array. However, the amount of the thus-induced electric field is so small that the electric field hardly expands beyond side array 306 in the −Y direction. For the same reason, the electric field hardly expands beyond side array 307 in the +Y direction.

Therefore, even in the case where antenna apparatus 108 is coupled with wireless module board 102 by means of soldering, the arrangement of the parasitic elements of side arrays 306 and 307 in this way can provide the following advantage. That is, the arrangement in this way can suppress the coupling of electric fields to mounting pads 321 and 322 and to the solder balls (not shown) disposed on the pads, with the electric fields being generated at the area surrounding feed element 304 and at the areas surrounding each of the parasitic elements of the front array 305. This suppression allows a reduction in influence of the coupling of the electric fields on a radiation pattern.

In the first embodiment, the descriptions have been made regarding the antenna apparatus that is equipped with the end-fire antenna including the feed element and the front array. The antenna apparatus outputs an electromagnetic wave in the direction from the feed element toward the front array, through use of the feed element and the front array. In this configuration, the antenna apparatus is further equipped with the first side array and the second side array. These side arrays are disposed at locations where the first and second side arrays sandwich both the feed element and the front array, from both sides of a reference axis which is determined along the radiation direction desired. The first and second side arrays have the positional relation in which the side arrays are disposed approximately in parallel to each other, with both the feed element and the front array being interposed between the side arrays as described above.

Note that the first and second side arrays are configured such that electric field E1 is approximately bilaterally symmetrical with respect to the reference axis, with electric field E1 being generated at the area surrounding the feed element and at the area surrounding each of the parasitic elements of the front array. This configuration allows a further reduction in the left-right inclination of directivity of the electromagnetic wave. Moreover, each of the first and second side arrays is disposed at approximately the same distance away from the end-fire antenna including the feed element and the front array, for example.

### 1.4. Modified Examples

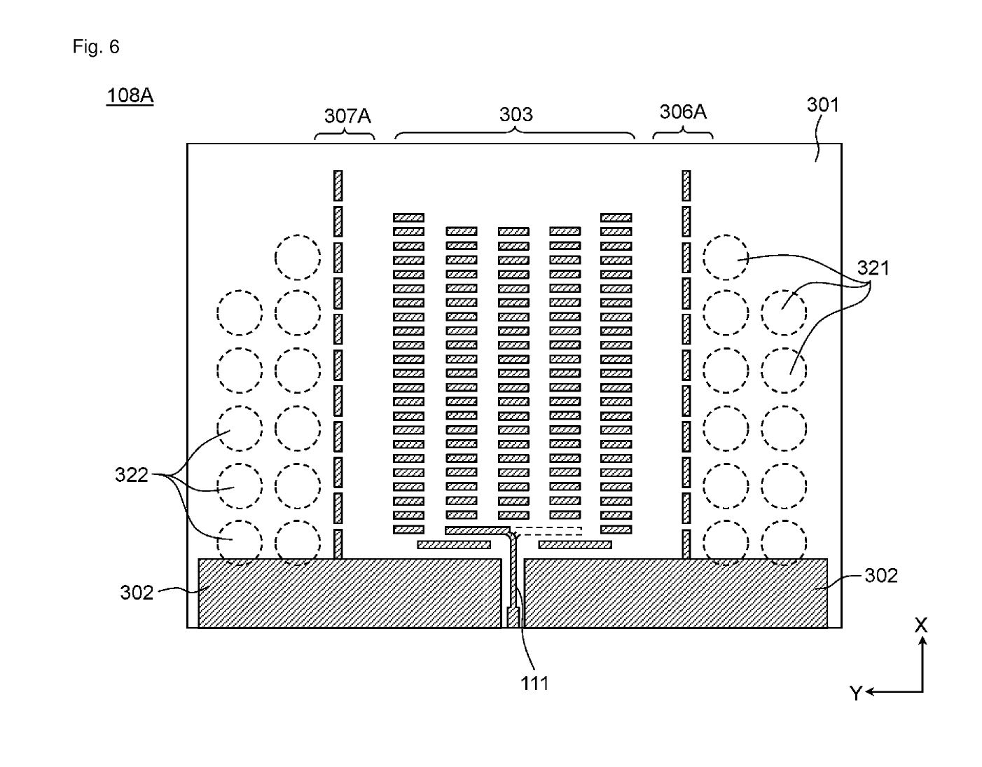

FIG. 6 is a plan view of a configuration of antenna apparatus 108A according to a first modified example of the first embodiment. Antenna apparatus 108A shown in FIG. 6 includes side arrays 306A and 307A instead of side arrays 306 and 307 shown in FIG. 2. Each of side arrays 306A and 307A may be devoid of a plurality of side sub-arrays.

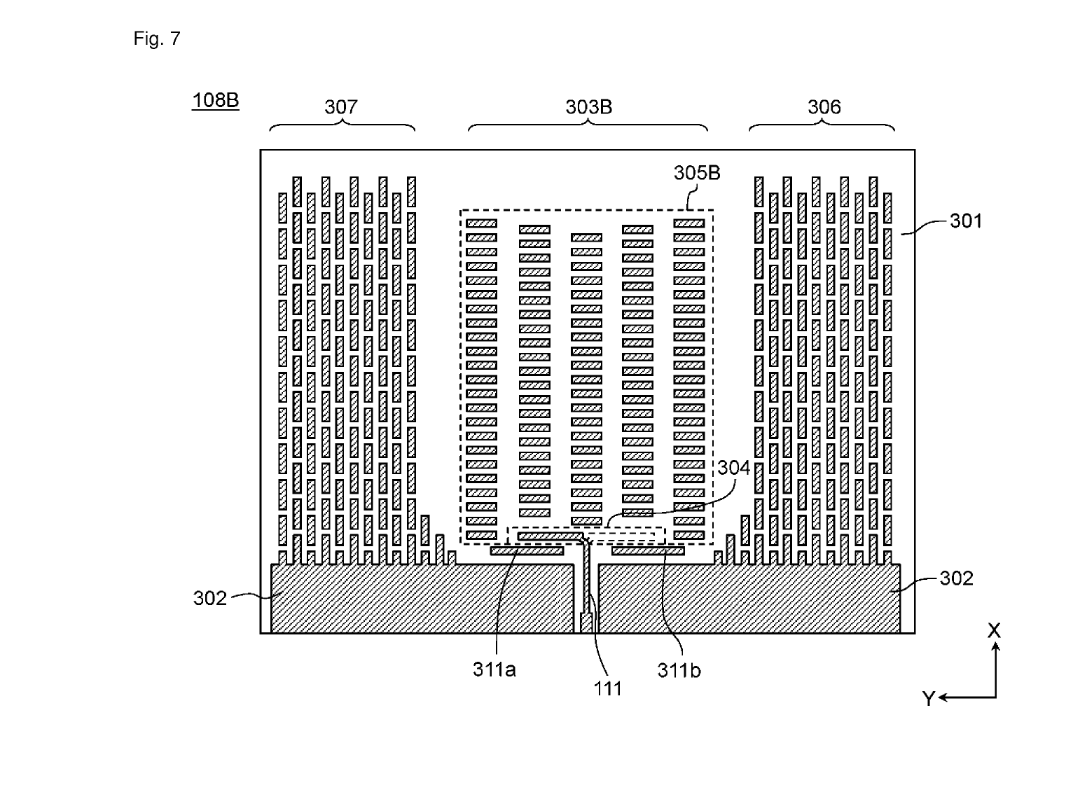

FIG. 7 is a plan view of a configuration of antenna apparatus 108B according to a second modified example of the first embodiment. Antenna apparatus 108B shown in FIG. 7 includes front array 305B instead of front array 305 shown in FIG. 2. A plurality of front sub-arrays of front array 305B is disposed such that, in any adjacent two of the front sub-arrays, each of the parasitic elements of one of the two front sub-arrays is positioned in a staggered arrangement with the corresponding one of the parasitic elements of the other of the two. Feed element 304 and front array 305B operate as end-fire antenna 303B.

As in the case of antenna apparatus 108 in FIG. 1, each of antenna apparatus 108A in FIG. 6 and antenna apparatus 108B in FIG. 7 can be coupled with wireless module board 102 by means of soldering, with the influence on a radiation pattern being successfully reduced.

The antenna apparatus according to the first embodiment further includes the following modified examples.

In the Figures including FIGS. 2 and 3, two feed element parts 304a and 304b of feed element 304 are formed respectively on the surfaces on both sides of dielectric substrate 301; however, both of two feed element parts 304a and 304b may be formed on the same surface of dielectric substrate 301.

In the Figures including FIGS. 2 and 3, feed element 304 is exemplified by a dipole antenna; however, the embodiments according to the present disclosure are not limited to this. The descriptions having been made in the first embodiment are applicable to another antenna as long as it can provide a horizontally polarized wave in the plane (X-Y plane) including dielectric substrate 301 and offer one radiation direction (+X direction). For this reason, even if an inverted-F antenna is used as the feed element, for example, it is possible to configure an antenna apparatus that can operate in the same way as for the antenna apparatus according to the first embodiment.

In the Figures including FIG. 2, reflective elements 311a and 311b may be omitted from the antenna apparatus.

Note that the dimensions and arrangement of the parasitic elements in each of the side arrays are not limited to the configuration (i.e., 2×D31+D33<λ/2) shown in FIG. 5. The dimensions and arrangement may have another configuration (e.g., a combination of other lengths) as long as the configuration can suppress occurrence of resonance of each parasitic element of each of the side arrays, with the resonance having a resonance wavelength equal to operating wavelength λ of feed element 304.

In the Figures including FIGS. 2 and 3, the parasitic elements of the side arrays are exemplified by using the case in which all of the parasitic elements are mounted only on one side of the printed-circuit substrate. However, the parasitic elements of the side arrays may be mounted on both sides of the printed-circuit substrate or, alternatively, on an intermediate layer and the like.

Moreover, in the Figures including FIG. 2, the parasitic elements of each of the side arrays are exemplified by using the case in which the plurality of the parasitic elements is disposed in approximately straight lines. However, the embodiments according to the present disclosure are not limited to this. The parasitic elements of each of the side arrays may be disposed along curved lines. The arrangement of the parasitic elements of the side arrays are not particularly limited, as long as the arrangement can restrict a region in which the influence of the electric field from the antenna apparatus expands or can make the expansion of the electric field bilaterally symmetrical. For example, the parasitic elements of each of the side arrays may be disposed in approximately straight lines that are at a fixed angle relative to the radiation direction (+X direction).

Moreover, in the Figures including FIG. 2, of the parasitic elements of each of the side arrays, the parasitic elements located on the most −X side are shown to be in contact with ground conductor 302. However, the parasitic elements located on the most −X side may be disposed away from ground conductor 302. Like this, of the parasitic elements of each of the side arrays, the parasitic elements located on the most +X side are shown in the Figures to reach (be in contact with) an edge on the +X side of dielectric substrate 301. However, the parasitic elements located on the most +X side need not necessarily to reach (be in contact with) the edge.

Note that, although distance D34 between the side sub-arrays is set equal to about width D32 of each of the parasitic elements, distance D34 may be set to be any other length.

Moreover, the side sub-arrays are disposed such that, in any adjacent two of the side sub-arrays, gaps between the parasitic elements of one of the two are positioned in a staggered arrangement with gaps between the parasitic elements of the other. However, these gaps may be disposed not in a staggered arrangement. In the plurality of the side sub-arrays, all the gaps between the parasitic elements may be disposed in the same arrangement. Alternatively, all the gaps in different side sub-arrays may be disposed in different arrangements from each other.

Moreover, the number of the side sub-arrays included in each of the side arrays may be different from that shown in FIG. 2. It is considered, however, that, the larger the number of the side sub-arrays, the more stable the direction of the beam radiated from the antenna apparatus is, without an inclination relative to the desired radiation direction (+X direction). In addition, the number of the side sub-arrays of one of the side arrays may be different from the number of the side sub-arrays of the other side array.

Moreover, the descriptions have been made by using the example of the antenna apparatus that is tuned for use in the millimeter waveband. However, the frequency used is not limited to one in the millimeter waveband.

Furthermore, the antenna apparatus may include a plurality of the end-fire antennas on the dielectric substrate.

### 2. SECOND EXEMPLARY EMBODIMENT

A second embodiment will be described, focusing on points different from those of the first embodiment; therefore, descriptions of the same parts as those of the first embodiment will be omitted for the sake of brevity.

### 2.1. Configuration

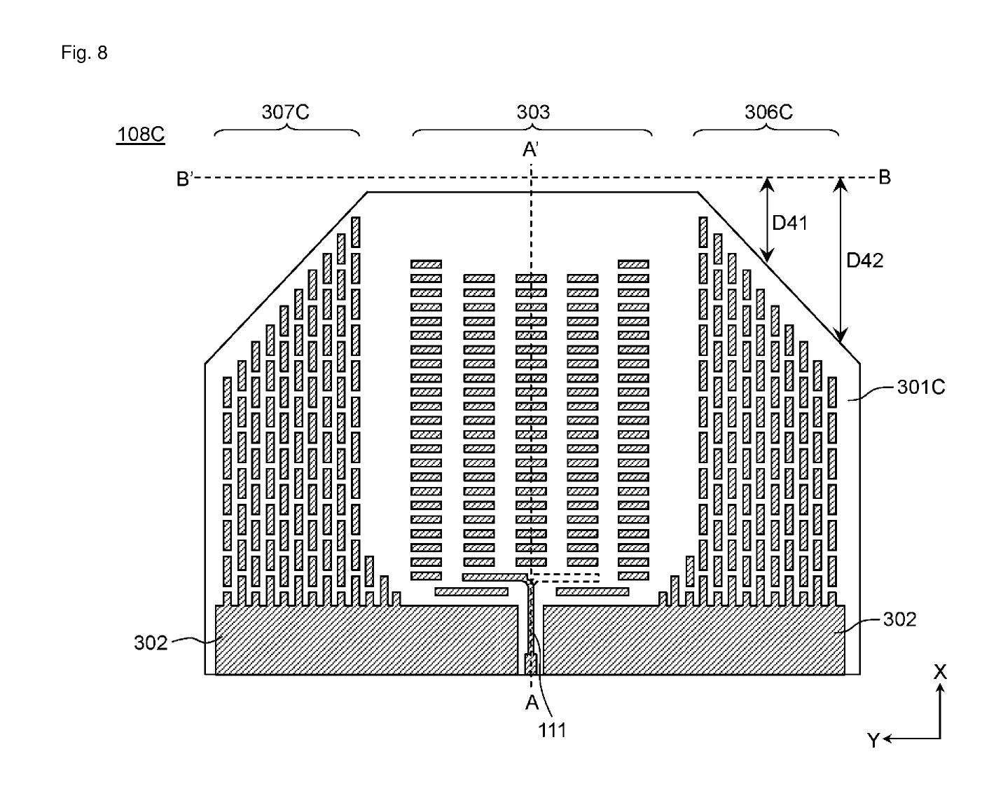

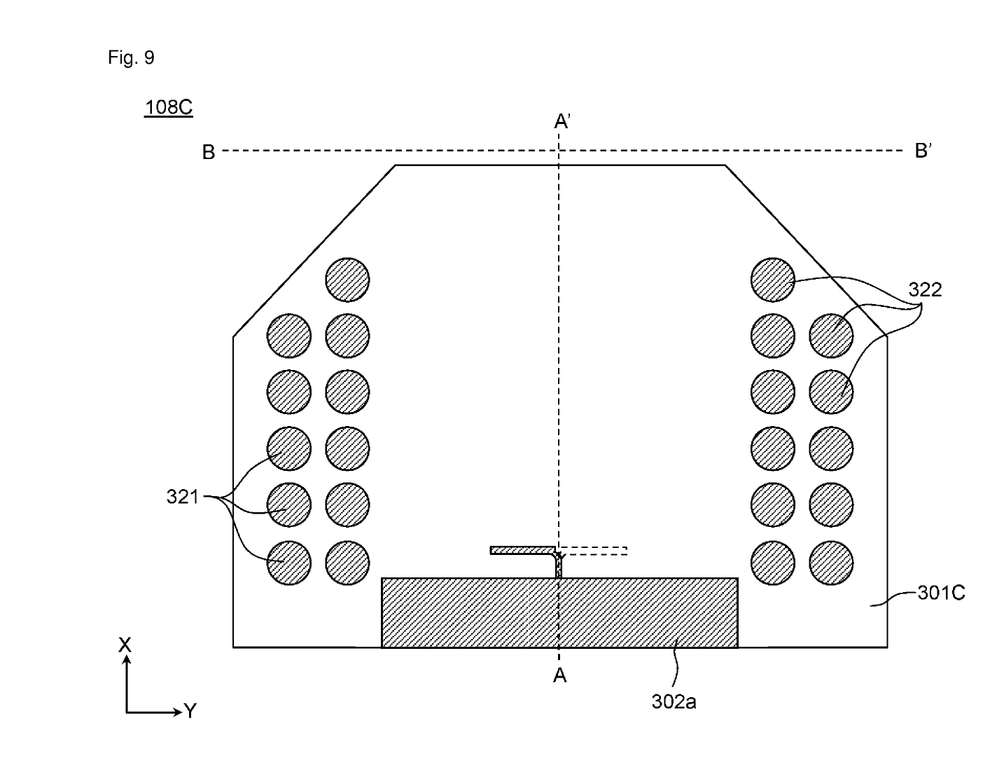

FIG. 8 is a plan view of a configuration of an upper surface of antenna apparatus 108C according to the second embodiment. FIG. 9 is a plan view of a configuration of a lower surface of antenna apparatus 108C shown in FIG. 8.

Antenna apparatus 108C shown in FIG. 8 includes dielectric substrate 301C and side arrays 306C and 307C, instead of dielectric substrate 301 and side arrays 306 and 307 shown in FIG. 2. The dielectric substrate has an edge different from that of dielectric substrate 301 shown in FIG. 2; the side arrays are disposed such that their arrangement pattern follows the shape of the edge of dielectric substrate 301C.

Here, as shown in FIGS. 8 and 9, a reference plane (passing through B-B′ in FIGS. 8 and 9) is assumed as a radiation opening face, with the reference plane being orthogonal to the radiation direction and being positioned in the radiation direction when vied from dielectric substrate 301C.

First, prior to comparison of the configurations, a description is made regarding travelling of the electromagnetic field in antenna apparatus 108 shown in FIG. 2. In FIG. 2, the electromagnetic field generated by exciting feed element 304 propagates in the radiation direction, and then radiates from the edge on the +X side of dielectric substrate 301. The distance of a travelling path of the electromagnetic field is considered which is from feed element 304 to the radiation opening face (corresponding to reference plane B-B′ in FIG. 8). The greater the deviation of the travelling path away from the center line in the ±Y directions, the larger the travelling distance is, relative to the travelling distance of the electromagnetic field which travels along reference line A-A′. That is, on the radiation opening face, the electromagnetic field has a larger phase delay at a greater distance away from reference line A-A′ in the ±Y directions, resulting in a factor in degrading the directivity gain of radiation. In addition, electromagnetic field leakage occurs at positions in the +X direction of side arrays 306 and 307, which influences the electromagnetic field distribution on the radiation opening face, with the distribution forming the radiation.

Thus, as shown in FIGS. 8 and 9, dielectric substrate 301C is configured to have the edge with the shape as follows: Distances (D41, D42, and the like) are considered here which are from reference plane B-B′ to points of intersections between the edge and lines that extend along the side sub-arrays of each of side arrays 306C and 307C. Each of the distances concerned becomes larger at a greater distance from feed element 304 and front array 305 to the corresponding side sub-array of corresponding one of side arrays 306C and 307C. With this configuration, an air layer between the edge of dielectric substrate 301C and reference plane B-B′ becomes thicker at a greater distance away from reference line A-A′ in the ±Y directions. Phase velocity of the electromagnetic wave is higher in air than in the dielectric. For this reason, such a shape of the substrate as shown in FIG. 8 allows the electromagnetic field distribution at reference plane B-B′ to become closer to an equiphase distribution, resulting in an increase in antenna gain.

### 2.2. Modified Examples

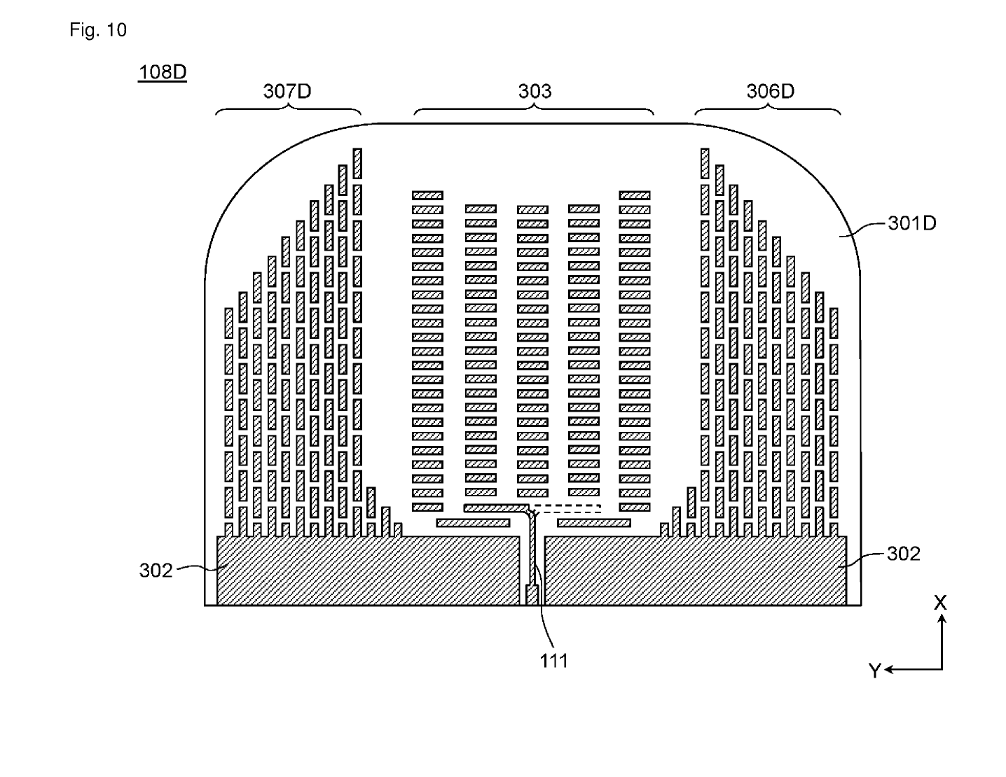

FIG. 10 is a plan view of a configuration of antenna apparatus 108D according to a modified example of the second embodiment. Antenna apparatus 108D shown in FIG. 10 includes dielectric substrate 301D that has an edge with another shape different from that of dielectric substrate 301C in FIG. 8, instead of dielectric substrate 301C shown in FIG. 8. The shape of the edge of the dielectric substrate is not limited to the straight line as shown in FIG. 8; therefore, the shape may be a curve. Side arrays 306D and 307D of antenna apparatus 108D are disposed such that their arrangement pattern follows the shape of the edge of dielectric substrate 301D, in the same manner as for side arrays 306C and 307C in FIG. 8.

As in the case of antenna apparatus 108C in FIG. 8, antenna apparatus 108D in FIG. 10 is configured with dielectric substrate 301D having a shape that also allows the electromagnetic field distribution to become closer to an equiphase distribution on a reference plane that is orthogonal to the radiation direction and is positioned in the radiation direction when vied from dielectric substrate 301D, resulting in an expected increase in antenna gain.

The antenna apparatus according to the second embodiment further includes the following modified examples.

The principle described in the second embodiment is also applicable to the case where the antenna apparatus does not include the mounting pads. In this case as well, the edge of the dielectric substrate has the following shape, so that the equiphase surface of the electromagnetic wave transmitted and received by the antenna apparatus coincides substantially with the reference plane. The shape is as follows: Distances from the reference plane to intersections between the edge of the dielectric substrate and lines that extend along the side sub-arrays of each of the side arrays, become larger at a greater distance away from the feed element and the front array to the corresponding side sub-array. This antenna apparatus with such a dielectric substrate allows an advantage of increased gain, over the antenna apparatus with the dielectric substrate having a rectangular shape, for example, as shown in FIG. 1.

In the second embodiment, the configurations of other modified examples described in the first embodiment are also applicable.

### 3. EXAMPLES

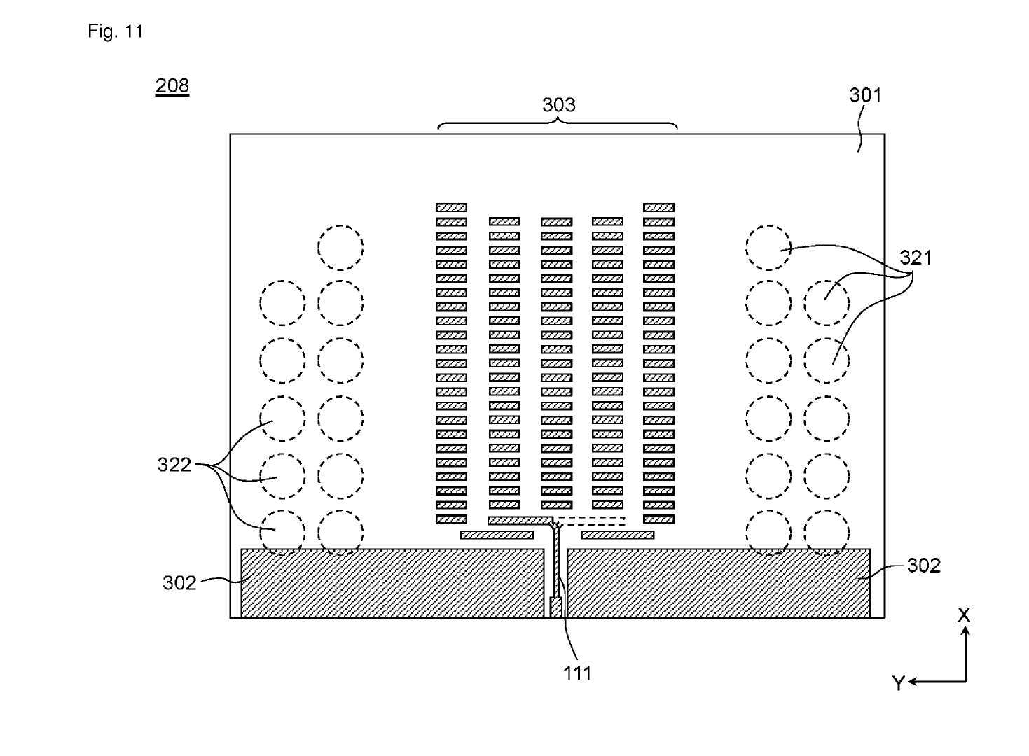

Hereinafter, the result of an electromagnetic field analysis of the antenna apparatus according to the embodiments will be described with reference to FIGS. 11 to 14.

FIG. 11 is a plan view of a configuration of antenna apparatus 208 according to a comparative example. Antenna apparatus 208 shown in FIG. 11 has the same configuration as that of antenna apparatus 108 shown in FIG. 1 except for side arrays 306 and 307 that are removed from the configuration.

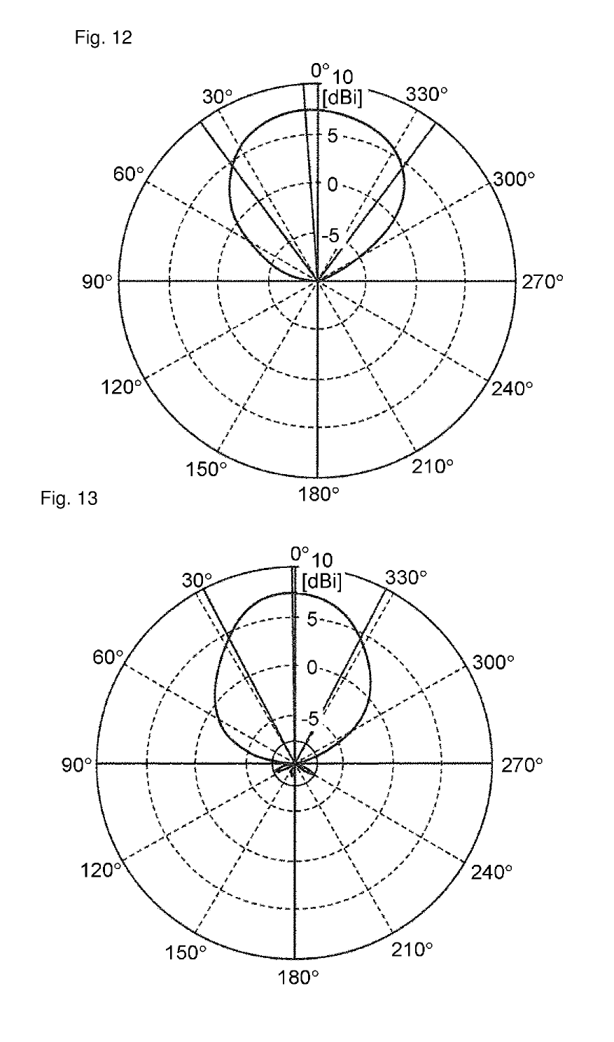

FIG. 12 is a chart of radiation directivity on an XY plane which shows the result of the electromagnetic field analysis of antenna apparatus 208 shown in FIG. 11. Longitudinal length D11 of each of feed element parts 304a and 304b of feed element 304 is 0.90 mm. For front array 305, longitudinal length D21 of each of the parasitic elements is 0.40 mm; distance D23 between two parasitic elements adjacent to each other in the longitudinal direction of each of the front sub-arrays is 0.10 mm; and distance D24 between two front sub-arrays adjacent to each other is 0.34 mm. The diameter of each of the mounting pads 321 and 322 is 0.60 mm. The result of the analysis shown in FIG. 12 indicates that antenna apparatus 208 exhibits a gain of 7.4 dBi and a half-power width of 72.8 degrees.

FIG. 13 is a chart of radiation directivity on an XY plane which shows the result of the electromagnetic field analysis of antenna apparatus 108 shown in FIG. 1. Dimensions of feed element 304, front array 305, and mounting pads 321 and 322 are the same as those for the electromagnetic field analysis shown in FIG. 12. Longitudinal length D31 of each of the parasitic elements of side arrays 306 and 307 is 0.40 mm. Distance D33 of the gap between two parasitic elements adjacent to each other in the longitudinal direction of each of the side sub-arrays is 0.10 mm. Distance D34 between two side sub-arrays adjacent to each other is 0.10 mm. The result of the analysis shown in FIG. 13 indicates that antenna apparatus 108 exhibits a gain of 7.4 dBi and a half-power width of 55.6 degrees. Therefore, it can be seen from the result that, in antenna apparatus 108 shown in FIG. 1, the influence of mounting pads 321 and 322 on the radiation directivity is reduced.

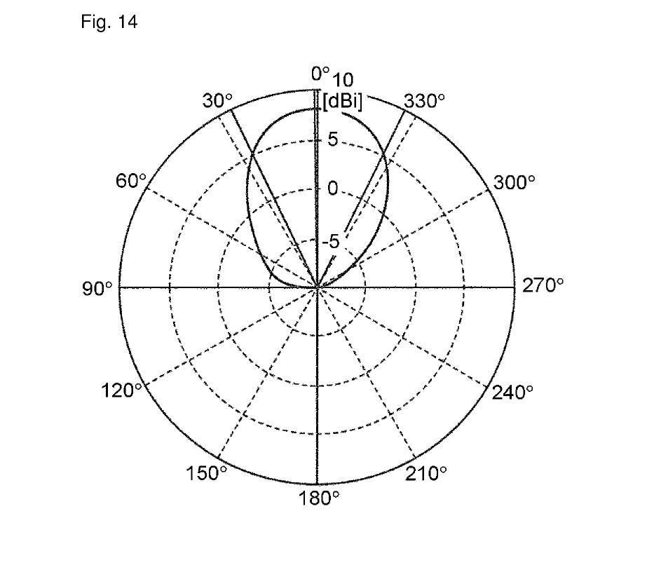

FIG. 14 is a chart of radiation directivity on an XY plane which shows the result of the electromagnetic field analysis of antenna apparatus 108C shown in FIG. 8. The result of the analysis shown in FIG. 14 indicates that antenna apparatus 108C exhibits a gain of 8.8 dBi and a half-power width of 52.3 degrees. Thus, the result indicates that antenna apparatus 108C shown in FIG. 8 is improved in gain over antenna apparatus 108 shown in FIG. 1.

### 4. OTHER EXEMPLARY EMBODIMENTS

As described above, the first and second embodiments have been described to exemplify the technology disclosed in the present application. However, the technology is not limited to these embodiments, and is also applicable to embodiments that are subjected, as appropriate, to various changes and modifications, replacements, additions, omissions, and the like. Moreover, the technology disclosed herein also allows another embodiment which is configured by combining the appropriate constituent elements in the first and second embodiments described above.

As described above, the exemplary embodiments have been described to exemplify the technology according to the present disclosure. To that end, the accompanying drawings and the detailed descriptions have been provided.

Therefore, the constituent elements described in the accompanying drawings and the detailed descriptions may include not only essential elements for solving the problems, but also inessential ones for solving the problems which are described only for the exemplification of the technology described above. For this reason, it should not be acknowledged that these inessential elements are considered to be essential only on the grounds that these inessential elements are described in the accompanying drawings and/or the detailed descriptions.

Moreover, because the aforementioned embodiments are used only for the exemplification of the technology disclosed herein, it is to be understood that various changes and modifications, replacements, additions, omissions, and the like may be made to the embodiments without departing from the scope of the appended claims or the scope of their equivalents.

### INDUSTRIAL APPLICABILITY

The technology according to the present disclosure is usable in wireless communication apparatuses and electronic apparatuses, which are each equipped with an antenna apparatus in which directivity is required. Such an antenna apparatus can be used for a short-range file transfer over a distance of 1 to 3 meters, for example.

What is claimed is:

1. An antenna apparatus comprising:
a dielectric substrate;
a front array including:
a feed element formed on the dielectric substrate and offering one radiation direction; and
a plurality of parasitic elements formed, on the dielectric substrate, in a region located in the radiation direction when viewed from the feed element, wherein the plurality of the parasitic elements configures a plurality of front sub-arrays such that each of the front sub-arrays includes a plurality of the parasitic elements arrayed along the radiation direction, and wherein the front sub-arrays are disposed in parallel with each other along the radiation direction such that, in any adjacent two of the front sub-arrays, each of the parasitic elements of one of the two is close to a corresponding one of the parasitic elements of the other of the two;
a first side array including
a plurality of parasitic elements formed, on the dielectric substrate, in a region located in a first direction orthogonal to the radiation direction when viewed from the feed element and the front array, the plurality of the parasitic elements of the first side array being arrayed substantially along the radiation direction;
a second side array including
a plurality of parasitic elements formed, on the dielectric substrate, in a region located in a second direction opposite to the first direction when viewed from the feed element and the front array, the plurality of the parasitic elements of the second side array being arrayed substantially along the radiation direction;
at least one first mounting pad disposed, on the dielectric substrate, in a region located in the first direction when viewed from the feed element and the front array, for coupling the antenna apparatus to a different substrate by soldering; and
at least one second mounting pad disposed, on the dielectric substrate, in a region located in the second direction when viewed from the feed element and the front array, for coupling the antenna apparatus to the different substrate by soldering,
wherein a part of the plurality of the parasitic elements of the first side array is disposed between the first mounting pad and both the feed element and the front array, and
a part of the plurality of the parasitic elements of the second side array is disposed between the second mounting pad and both the feed element and the front array.

2. The antenna apparatus according to claim 1, wherein the dielectric substrate includes a first surface and a second surface, the parasitic elements of the first and second side arrays are disposed on the first surface, and the first and second mounting pads are disposed on the second surface.

3. The antenna apparatus according to claim 1, wherein, in each of the first and second side arrays, the plurality of the parasitic elements of the side array configures a plurality of side sub-arrays disposed in parallel with each other substantially along the radiation direction, and
each of the side sub-arrays includes a plurality of the parasitic elements of the side array, the parasitic elements being arrayed substantially along the radiation direction.

4. The antenna apparatus according to claim 2, wherein, in each of the first and second side arrays, the plurality of the parasitic elements of the side array configures a plurality of side sub-arrays disposed in parallel with each other substantially along the radiation direction, and
each of the side sub-arrays includes a plurality of the parasitic elements of the side array, the parasitic elements being arrayed substantially along the radiation direction.

5. The antenna apparatus according to claim 3, wherein, the dielectric substrate includes an edge having a shape providing intersections with lines along the side sub-arrays such that an equiphase surface of an electromagnetic wave transmitted and received by the antenna apparatus coincides substantially with a reference plane, the reference plane being orthogonal to the radiation direction and located in the radiation direction when viewed from the dielectric substrate, a distance from the reference plane to each of the intersections increasing at a greater distance from both the feed element and the front array to a corresponding one of the side sub-arrays.

6. The antenna apparatus according to claim 4, wherein, the dielectric substrate includes an edge having a shape providing intersections with lines along the side sub-arrays such that an equiphase surface of an electromagnetic wave transmitted and received by the antenna apparatus coincides substantially with a reference plane, the reference plane being orthogonal to the radiation direction and located in the radiation direction when viewed from the dielectric substrate, a distance from the reference plane to each of the intersections increasing at a greater distance from both the feed element and the front array to a corresponding one of the side sub-arrays.

7. The antenna apparatus according to claim 3, wherein, the plurality of the side sub-arrays of each of the first and second side arrays is disposed such that, in any adjacent two of the side sub-arrays, gaps between the parasitic elements of one of the two are positioned in a staggered arrangement with gaps between the parasitic elements of the other.

8. The antenna apparatus according to claim 4, wherein, the plurality of the side sub-arrays of each of the first and second side arrays is disposed such that, in any adjacent two of the side sub-arrays, gaps between the parasitic elements of one of the two are positioned in a staggered arrangement with gaps between the parasitic elements of the other.

9. The antenna apparatus according to claim 5, wherein, the plurality of the side sub-arrays of each of the first and second side arrays is disposed such that, in any adjacent two of the side sub-arrays, gaps between the parasitic elements of one of the two are positioned in a staggered arrangement with gaps between the parasitic elements of the other.

10. The antenna apparatus according to claim 6, wherein, the plurality of the side sub-arrays of each of the first and second side arrays is disposed such that, in any adjacent two of the side sub-arrays, gaps between the parasitic elements of one of the two are positioned in a staggered arrangement with gaps between the parasitic elements of the other.

11. The antenna apparatus according to claim 1, wherein, each of the parasitic elements of the first and second side arrays has a longitudinal direction along a longitudinal direction of the corresponding side array; and,
in each of the first and second side arrays, a sum of longitudinal lengths of any two of the parasitic elements adjacent to each other in the longitudinal direction of the corresponding side array and a length of a gap between the two is smaller than a half of an operating wavelength of the feed element.

12. The antenna apparatus according to claim 1, wherein a distance from the front array to the first side array is substantially equal to a distance from the front array to the second side array.

13. The antenna apparatus according to claim 1,
wherein the feed element is a dipole antenna having a longitudinal direction orthogonal to the radiation direction, and
each of the plurality of the parasitic elements of the front array has a longitudinal direction orthogonal to the radiation direction.

14. The antenna apparatus according to claim 13, wherein the plurality of the front sub-arrays of the front array is disposed such that, in any adjacent two of the front sub-arrays, each of the parasitic elements of one of the two is positioned in a staggered arrangement with corresponding one of the parasitic elements of the other of the two.

15. A wireless communication apparatus comprising:
the antenna apparatus according to claim 1; and
a wireless communication circuit coupled with the antenna apparatus.

16. An electronic apparatus comprising:
the wireless communication apparatus according to claim 15; and
a signal processor for processing a signal transmitted and received by the wireless communication apparatus.
